(19) United States
(12) Patent Application Publication
(10) Pub. No.: US 2026/0065944 A1
(43) Pub. Date: Mar. 5, 2026

(54) INDIUM-BASED SEALS FOR ELECTRONIC DEVICES

(71) Applicant: SEAGATE TECHNOLOGY LLC, Fremont, CA (US)

(72) Inventors: Wei Leng Tee, Singapore (SG); Min Won Bae, Singapore (SG); Khin Yuupar Htaing, Singapore (SG); Thanakorn Sangrit, Korat (TH)

(21) Appl. No.: 18/823,408

(22) Filed: Sep. 3, 2024

(51) Int. Cl. G11B 33/14

(52) U.S. Cl. CPC G11B 33/1466

(57) ABSTRACT

An electronic device includes a cover coupled to a base to create an enclosure. One or more electronic components are positioned within the enclosure. A metallic seal is positioned between the cover and the base. The seal can be formed as a pre-cut gasket comprising indium or a layer of electroplated indium.

### SUMMARY

Certain embodiments involve a hard disk drive with a cover coupled to a base to create an enclosure, data storage components positioned within the enclosure, and a seal positioned between the cover and the base. The seal comprises indium.

Certain embodiments involve a method for sealing an electronic device. The method includes positioning a seal between a cover and a base. The method further includes applying a force to the cover to compress the seal to create a hermetic seal. The seal comprises indium.

Certain embodiments involve a hard disk drive with a base, a cover coupled to the base to create an internal cavity, and means for sealing the internal cavity using indium.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a cut-away side view schematic of a hard disk drive, in accordance with certain embodiments of the present disclosure.

FIG. 2 shows a bottom perspective view of a cover and seal, in accordance with certain embodiments of the present disclosure.

FIG. 3 shows a cut-away side view of a portion of a hard disk drive with the cover and seal of FIG. 2, in accordance with certain embodiments of the present disclosure.

FIG. 4 shows a cut-away side view of a portion of a hard disk drive with an alternative seal design, in accordance with certain embodiments of the present disclosure.

FIG. 5 shows a perspective view of a bottom of a cover and a top perspective view of a top of a base of a hard disk drive, in accordance with certain embodiments of the present disclosure.

FIG. 6 shows a cut-away side view of a portion of a hard disk drive with the cover of FIG. 5, in accordance with certain embodiments of the present disclosure.

FIG. 7 shows a block diagram representing steps of a method, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Electronic devices such as data storage devices (e.g., hard disk drives) can be sealed to help protect internal components from being impacted by environment conditions external to the electronic devices.

Traditionally, to help provide a seal, hard disk drives have used a polymer-based form-in-place-gasket (FIPG) between a base and cover. However, FIPGs can outgas under certain conditions and impact performance of internal components of hard disk drives. For example, outgassed materials can migrate from the FIPGs and into various areas of the internal cavity of hard disk drives. If the outgassed materials deposit onto the magnetic recording media or the read/write heads, the materials can cause errors and/or failures. For example, the materials may interfere with a hard disk drive's ability to read data from the magnetic recording media or write data to the magnetic recording media.

Certain embodiments of the present disclosure feature electronic devices that use seals that are less likely to outgas compared to polymer-based FIPGs. In particular, certain embodiments of the present disclosure use seals that comprise indium instead of a polymer.

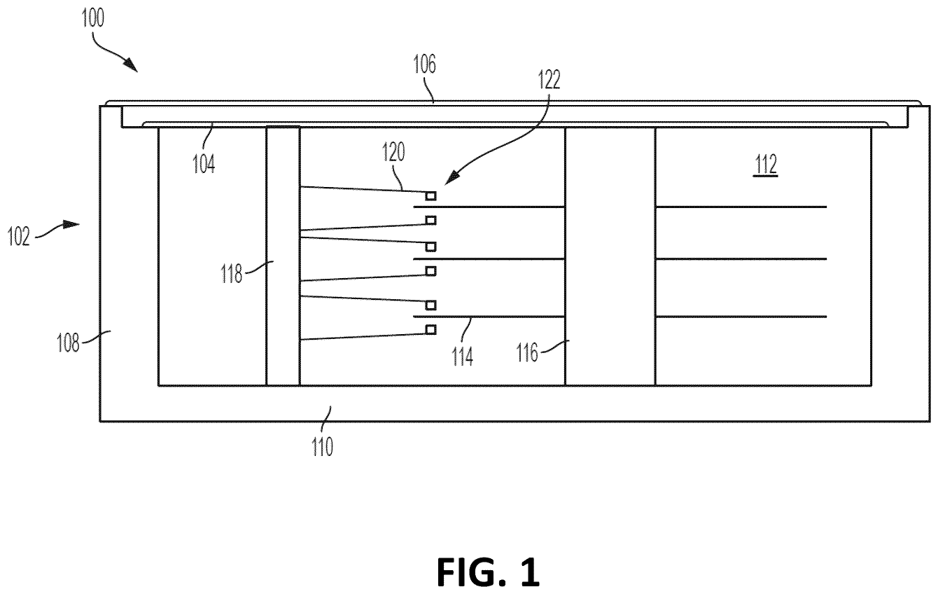

FIG. 1 shows a cut away side view of a hard disk drive 100 including a base deck 102, a process cover 104, and a final cover 106. The base deck 102 includes a sidewall 108 that, together with a bottom portion 110 of the base deck 102 and the process cover 104, create an enclosure with an internal cavity 112. The internal cavity 112 houses data storage components like magnetic recording media 114, a spindle motor 116, an actuator pivot bearing 118, suspensions 120, and read/write heads 122. The spindle motor 116 and the actuator pivot bearing 118 are shown in FIG. 1 as being coupled between the process cover 104 and the bottom portion 110 of the base deck 102.

During assembly, a seal can be positioned between the process cover 104 and the base deck 102, and then the process cover 105 can be coupled to the base deck 102 by removable fasteners (e.g., screws). The seal is used to seal a target gas (e.g., air with nitrogen and oxygen and/or a lower-density gas like helium) within the internal cavity 112. Once the process cover 104 and seal is coupled to the base deck 102, a target gas may be injected into the internal cavity 112 through an aperture in the process cover 104, which is subsequently sealed. Injecting the target gas, such as a combination of air and a low-density gas like helium (e.g., 90 percent or greater helium), may involve first evacuating existing gas from the internal cavity 112 using a vacuum and then injecting the target gas from a low-density gas supply reservoir into the internal cavity 112. The aperture in the process cover 104 can be sealed via an adhesive, weld, or the like to keep the target gas within the hard disk drive 100 and, in particular, the internal cavity 112. Once the process cover 104 is sealed, the hard disk drive 100 can be subjected to a variety of processes and tests. After the hard disk drive 100 is processed and passes certain tests, the internal cavity 112 may be refilled with the target gas and then resealed. Finally, the final cover 106 can be coupled to the base deck 102 via welding (e.g., friction stir welding, laser welding).

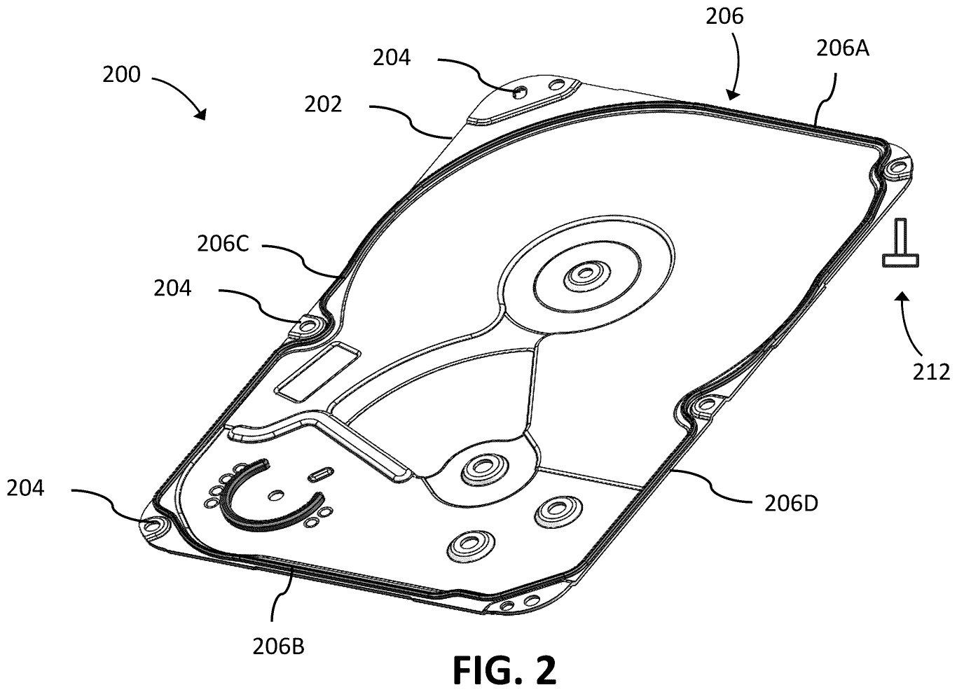

FIG. 2-6 show various designs for sealing a cover (e.g., a process cover) to a base (e.g., a sidewall of the base). Each of the designs can be used with various electronic devices such as the hard disk drive 100 shown in FIG. 1. The various designs can use a metallic seal (e.g., a seal comprising indium) instead of a polymer-based seal positioned between a cover and a base.

The designs are not mutually exclusive and can be combined with each other. For example, the gasket-like seal (e.g., a gasket comprising indium) described herein can be combined with seals that utilize an electroplated metal (e.g., a layer of electroplated indium).

Like the process cover 104 of FIG. 1, the covers of FIG. 2-6 can be used in combination with a second cover (e.g., a welded cover) to hermetically seal an interior cavity.

FIG. 2 shows a perspective view of a bottom side of a process cover 200 that could be used with the hard disk drive 100 of FIG. 1.

The process cover 200 defines an outer perimeter 202 and various through-holes 204 near the outer perimeter 202. The through-holes 204 are sized for fasteners (e.g., threaded fasteners such as screws) to pass through. A seal 206 is coupled to the bottom side of the process cover 200. The seal 206 is shaped such that it substantially matches a shape of the outer perimeter 202, except that the seal 206 curves inward to avoid interfering with the through-holes 204. The seal 206 can be shaped to include two shorter sections 206A, 206B that are generally parallel to each other and two longer sections 206C, 206D that are generally parallel to each other and that are longer than the other two sections 206A, 206B. Each section 206A-D can include a linear portion and a curved portion. The seal 206 can form one continuous seal that extends adjacent to the outer perimeter 202.

In certain embodiments, the seal 206 is a metallic seal that comprises indium. Indium is a metal that outgasses less than the type of polymers typically used for gaskets used in hard disk drives. The seal 206 can be pre-cut such that the seal 206 and its shape is created before being coupled to the process cover 200. The seal 206 can be considered to be an indium gasket (e.g., an indium pre-cut gasket).

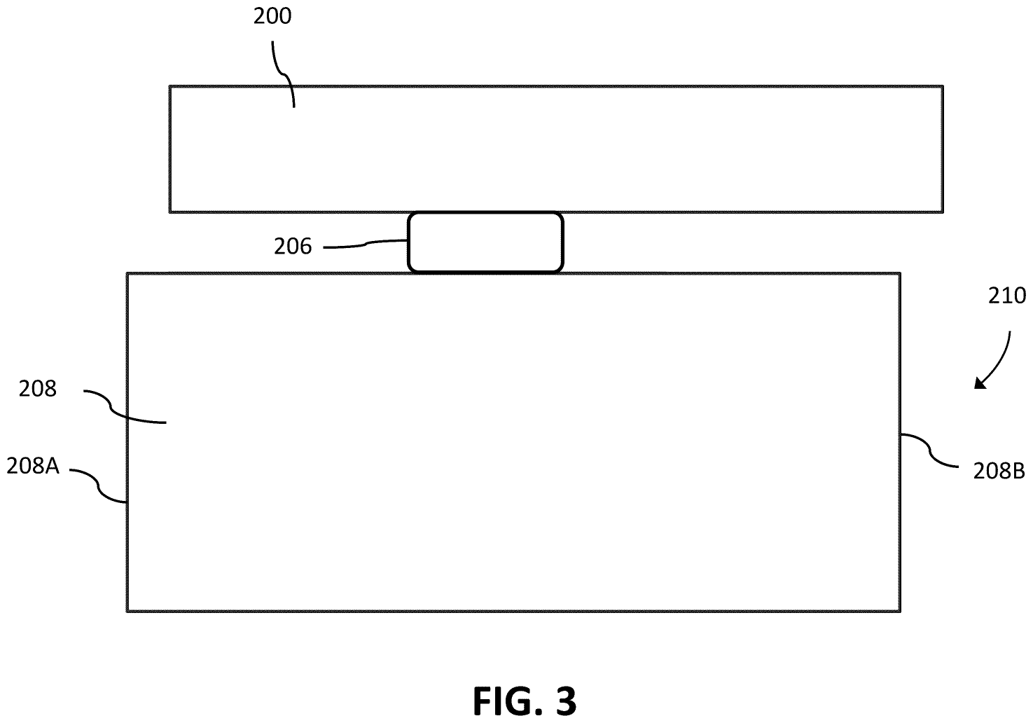

FIG. 3 shows a side view of a portion of a base (e.g., a portion of the sidewall 208), the process cover 200, and the seal 206 of a hard disk drive. The process cover 200 is sealed to the sidewall 208 of the base via the seal 206. The seal 206 is positioned between the process cover 200 and the sidewall 208. The seal 206 is directly coupled to a bottom surface of the process cover 200 and to a top surface of the sidewall 208. The seal 206 is also positioned between an exterior surface 208A and an interior surface 208B of the sidewall 208. The interior surface 208B faces an interior cavity 210 of the hard disk drive.

Before the process cover 200 is coupled to the sidewall 208, the seal 206 can be positioned on (or otherwise coupled to) the process cover 200 near the outer perimeter 202 of the process cover 200. When the process cover 200 is coupled to the sidewall 208, the seal 206 helps provide a seal (e.g., an air-tight seal) to help prevent contaminants (e.g., dust or other particles) from entering the internal cavity 210 of the hard disk drive. The process cover 200 can be coupled to the sidewall 208 via fasteners 212 (shown in FIG. 2) that extend through the through-holes 204 (also shown in FIG. 2) and into blind holes (e.g., threaded blind holes) in the sidewall 208. As the fasteners 212 are tightened, the seal 206 will begin to become compressed. Because indium is a metal that is soft and pliable, as the seal 206 is compressed, the seal 206 will deform and fill a gap between the process cover 200 and the sidewall 208 and seal the internal cavity 210 from the external environment. To the extent a portion of indium from the seal 206 flows out of the gap and past the exterior surface 208A of the sidewall 208, later processing (e.g., welding, material removal) can remove the extra material from the exterior of the hard disk drive.

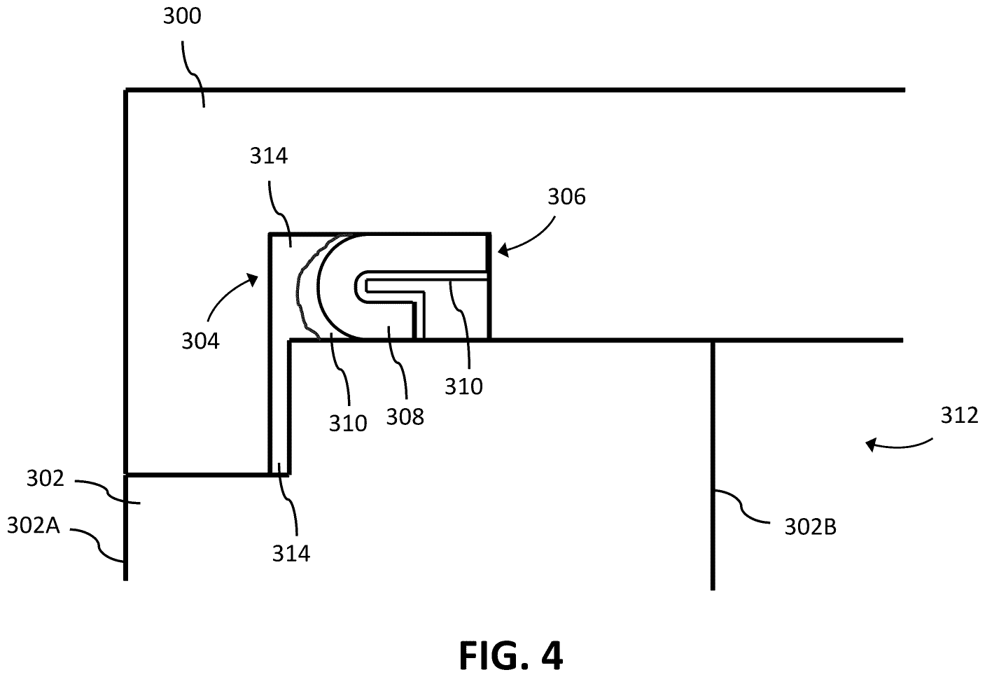

FIG. 4 shows a side view of a portion of a process cover 300 attached to a base (e.g., a sidewall 302) that could be used with the hard disk drive 100 of FIG. 1.

The process cover 300 includes a recessed section 304 (e.g., a channel, a notch, and the like). The recessed section 304 forms a reduced-thickness portion of the process cover 300 which is a portion of the process cover 300 that is thinner than at least some other portions of the process cover 300. The recessed section 304 is shaped and sized to accommodate a seal 306.

The seal 306 includes a substrate 308 and an outside layer 310. Both the substrate 308 and the outside layer 310 can comprise metallic materials. In certain embodiments, the outside layer 310 comprises indium, and the substrate 308 comprises a metal that is not indium such as steel (e.g., stainless steel). The substrate 308 can be shaped such that the substrate 308 can be compressed as the process cover 300 is coupled to the sidewall 302. In the example shown in FIG. 4, the substrate 308 is formed (e.g., bent) to form a C-shape or U-shape, however, other shapes can be used. In certain embodiments, the outside layer 310 can be plated (e.g., electroplated) onto the substrate 308.

The process cover 300 is sealed to the sidewall 302 of the base via the seal 306. The seal 306 is positioned between the process cover 300 and the sidewall 302 as well as between an exterior surface 302A and an interior surface 302B of the sidewall 302. The seal 306 can be directly coupled to a bottom surface of the process cover 300 (e.g., one or more surfaces of the recessed section 304) and to a top surface of the sidewall 302.

Before the process cover 300 is coupled to the sidewall 302, the seal 306 can be positioned on (or otherwise coupled to) the process cover 300 within the recessed section 304 of the process cover 300. When the process cover 300 is coupled to the sidewall 302, the seal 306 helps provide a seal to help prevent contaminants from entering the internal cavity 312 of the hard disk drive. The process cover 300 can be coupled to the sidewall 302 via fasteners that extend through through-holes and into blind holes in the sidewall 302. As the fasteners are tightened, the seal 306 will begin to become compressed. The outside layer 310 (e.g., the electroplated indium layer) will become compressed and flow and fill gaps between the process cover 300 and the sidewall 302 and seal the internal cavity 312 from the external environment. More particularly, as the seal 306 is compressed, excess material (e.g., excess indium) from the outside layer 310 will flow to either side of the substrate 308 and fill gaps (such as gaps 314 in FIG. 4) and seal the internal cavity 312.

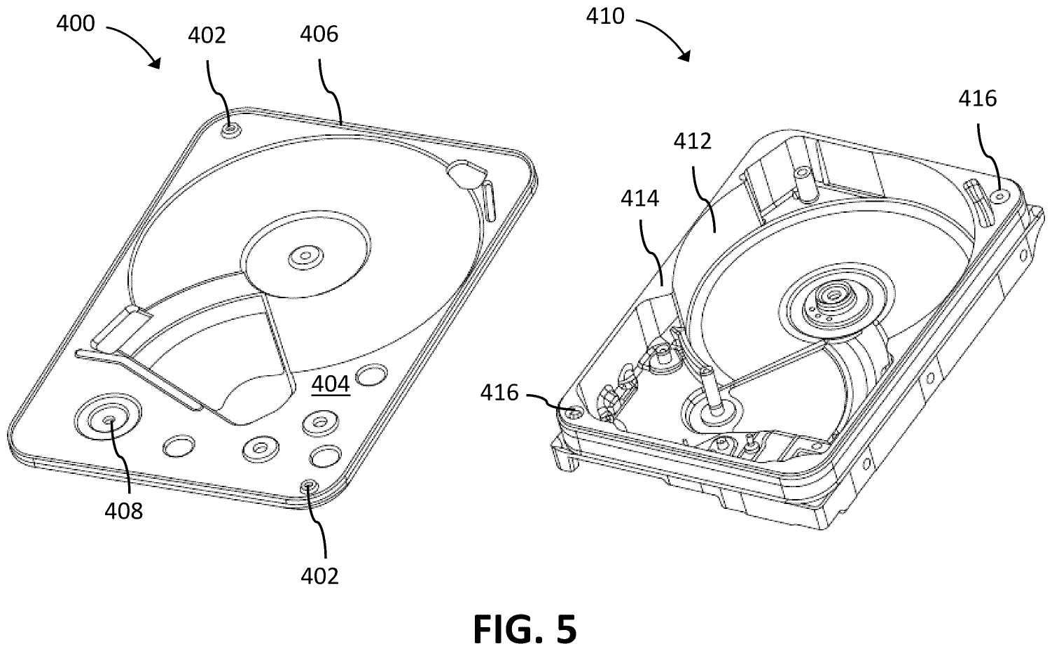

FIG. 5 shows a perspective view of a bottom side of a process cover and a perspective view of a top side of a base that could be used with the hard disk drive 100 of FIG. 1.

The process cover 400 defines an outer perimeter and includes at least two protrusions 402 extending from a bottom surface 404 of the process cover 400. In the example of FIG. 5, the protrusions 402 are positioned near corners of the process cover 400. In particular, the protrusions 402 are positioned at diagonally opposing corners of the process cover 400. As will be described in more detail below, the protrusions 402 are shaped and sized to fit into corresponding holes in the base to assist with aligning the process cover 400 and the base. The protrusions 402 can have various shapes such as pin-shaped, cone-shaped, bump-shaped, volcano-shaped, and the like. In the example of FIG. 5, the protrusions 402 includes a center hole or concave surface on the bottom surface of the protrusions 402.

The process cover 400 also includes a rim 406 (e.g., sidewall) that extends around an outer periphery of the process cover 400. The rim 406 protrudes away from the bottom surface 404 of the process cover 400. As can be seen, the protrusions 402 are positioned within the boundary created by rim 406. The process cover 400 includes various through-holes 408. Some of the through-holes 408 are used to secure components such as a spindle motor, actuator bearing, and/or voice coil motor to the process cover 400. Another through-hole 408 is used as an aperture through which gas (e.g., a gas containing helium) is injected to at least partially fill the internal cavity with the gas. That through-hole 408 is then sealed to help prevent the injected gas from leaking from the internal cavity.

The process cover 400 can be electroplated with a metal such as indium. In certain instances, only portions of the process cover 400 are electroplated. One electroplated portion can include a bottom surface of the rim 406. Another portion can include an interior surface of the rim 406. Another portion can include some or all of the protrusions 402. Another portion can include a section of the bottom surface 404 of the process cover 400. For example, the electroplated section of the bottom surface 404 can include portions of the bottom surface 404 that will contact a top surface of the base (e.g., the top surface of the sidewall of the base) when the process cover 400 is coupled to the base.

A base 410 includes a sidewall 412 that forms an outer perimeter of the base 410. The sidewall 412 includes a top surface 414. In certain embodiments, the top surface 414 is electroplated with a metal such as indium. As will be described in more detail below, other surfaces of the sidewall 412 can be electroplated as well.

The base 410 includes holes 416 in the top surface 414 of the sidewall 412. The holes 416 can be positioned, shaped, and sized to correspond to the protrusions 402 on the process cover 400. For example, the holes 416 can be concave-shaped, cone-shaped, etc. In the example of FIG. 5, the holes 416 have a concave surface and a central bump. The number of holes 416 can correspond to the number of protrusions 402 in the process cover 400. When the process cover 400 is coupled to the base 410, the protrusions 402 of the process cover 400 can be aligned with the holes 416 of the base 410 to assist with accurately positioning the process cover 400 relative to the base 410. By using the protrusions 402 and the corresponding holes 416, there may be no need to use a fastener that extends into the sidewall 412 (although fasteners can be used with one or more of the through-holes 408 to couple the process cover 400 to other components of the base 410). In addition to the protrusions 402 and holes 416, the rim 406 of the process cover 400 can be aligned with an external surface of the sidewall 412 to assist with alignment of the process cover 400 relative to the base 410.

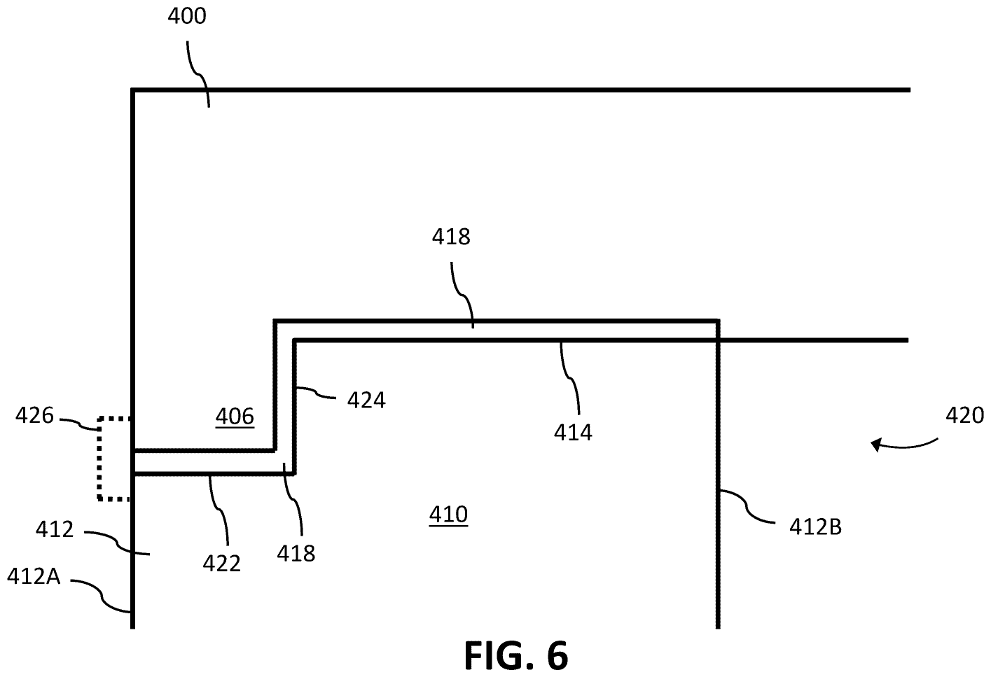

FIG. 6 shows a schematic side view of the top cover 400 coupled to the base 410. The process cover 400 is sealed to the sidewall 412 of the base 410 via a seal 418. The seal 418 is positioned between the process cover 400 and the sidewall 412. The seal 418 extends between an exterior surface 412A and an interior surface 412B of the sidewall 412. The interior surface 412B faces an interior cavity 420 of the hard disk drive.

The seal 418 can be created via cold welding the process cover 400 to the sidewall 412. For example, a force can be applied to the process cover 400 and/or the base 410 to compress the electroplated metal (e.g., the electroplated indium) of the process cover 400 and the base 410. As the indium is compressed, the process cover 400 will become secured (e.g., via cold welding) to the sidewall 412 (and therefore the base 410). In certain instances, before the electroplated surfaces are compressed and contact each other, oxide formed on the electroplated surface is removed to improve the quality of the cold weld (and therefore the quality of the seal 418). One example process includes using a chemical such as hydrochloric acid to remove oxidized indium from the surfaces of the electroplated indium. Once the seal 418 is formed, the seal 418 helps prevent contaminants from entering the internal cavity 420 of the hard disk drive.

As shown in FIG. 6, the sidewall 412 of the base 410 includes the top surface 414 as well as a lower surface 422 and a side surface 424 connecting the top surface 414 and the lower surface 422. The lower surface 422 and the side surface form a notch-like feature to accommodate the rim 406 of the process cover 400. The seal 418 can extend along all such surfaces (and corresponding surfaces of the process cover 400) to create a seal.

In certain situations, when the electroplated material is compressed, some of the material of the seal 418 flows out from the process cover 400 and the base 410. This excess material is represented in dotted lines and reference number 426. The excess material 426 can be removed by processes such as friction stir welding or a material removal process.

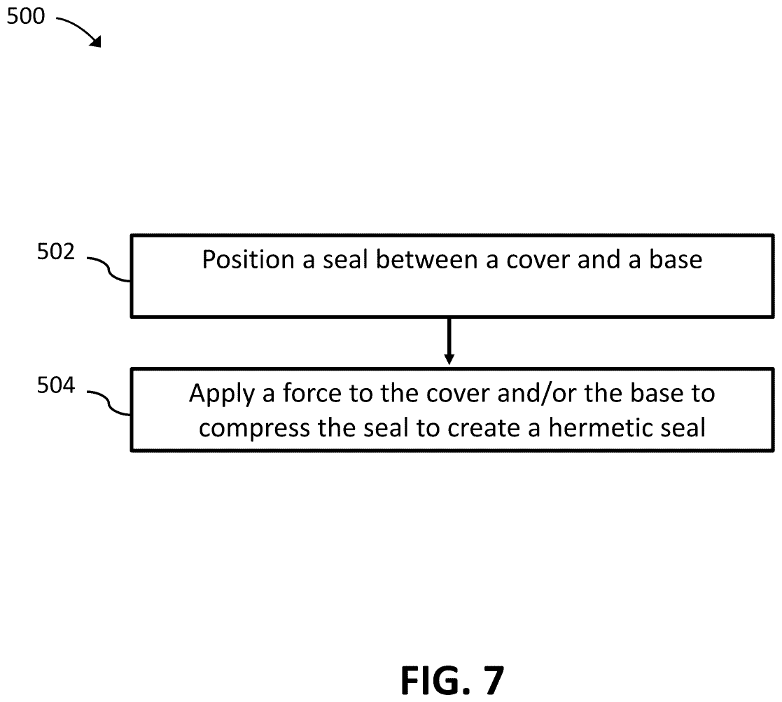

FIG. 7 outlines steps of a method 500 for sealing an electronic device such as a data storage device (e.g., a hard disk drive). The method 500 includes positioning a seal between a cover and a base (block 502 in FIG. 7), and the seal comprises indium. In certain embodiments, the seal is initially coupled to the cover before the cover is coupled to the base. In some embodiments, the seal comprises electroplated indium on the base.

The method 500 further includes applying a force to the cover and/or the base to compress the seal to create a hermetic seal (block 504 in FIG. 7). In certain embodiments, applying the force includes rotating fasteners (e.g., screws) to secure the cover against the base. The fasteners can be rotated simultaneously such that the force against the cover is applied substantially evenly along the cover. The approach may allow the seal to compress evenly between the cover and the base. In some embodiments, applying the force includes using a tool (e.g., a press) to press the cover and/or the base to the other.

In certain embodiments, compressing the seal causes the indium material to deform and flow to fill gaps between the cover and the base. For example, in embodiments with a recessed section in the cover, the indium material can flow to fill gaps in the recessed section. The indium material may flow beyond gaps between the cover and the base such that excess material flows out onto an external surface of the electronic device. The excess material can be removed (e.g., via a welding process or a material removal process) to provide a clear and uniform external surface.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A hard disk drive comprising:
a cover coupled to a base to create an enclosure;
data storage components positioned within the enclosure; and
a seal positioned between the cover and the base, wherein the seal comprises indium.

2. The hard disk drive of claim 1, wherein the seal is a pre-cut gasket comprising indium.

3. The hard disk drive of claim 1, wherein the seal comprises a substrate and a layer comprising the indium on the substrate.

4. The hard disk drive of claim 3, wherein the substrate comprises a metal that is not indium.

5. The hard disk drive of claim 3, wherein the layer is electroplated onto the substrate.

6. The hard disk drive of claim 1, wherein the seal is created by the cover being electroplated with indium.

7. The hard disk drive of claim 6, wherein the cover comprises a bottom surface that faces the base, wherein only a portion of the bottom surface is electroplated with indium.

8. The hard disk drive of claim 1, wherein the seal is created by the base being electroplated with indium.

9. The hard disk drive of claim 1, wherein the cover is coupled to the base via fasteners that compress the seal.

10. The hard disk drive of claim 1, wherein the cover is a process cover, wherein the hard disk drive further comprises a final cover that is welded to the base.

11. A method for sealing an electronic device, the method comprising:
positioning a seal between a cover and a base, wherein the seal comprises indium; and
applying a force to the cover to compress the seal to create a hermetic seal.

12. The method of claim 11, wherein the applying the force comprises rotating fasteners to secure the cover against the base.

13. The method of claim 11, further comprising removing excess indium from an external surface of the electronic device.

14. The method of claim 13, wherein the electronic device is a hard disk drive, wherein the cover is a process cover, the method further comprising welding a final cover to the base.

15. The method of claim 11, wherein the seal is a pre-cut gasket comprising indium.

16. The method of claim 11, wherein the seal comprises a metal substrate and a layer comprising the indium on the substrate.

17. The method of claim 11, wherein the layer is electroplated onto the substrate.

18. The method of claim 11, wherein the seal is created by the cover being electroplated with indium.

19. The method of claim 11, wherein the seal is created by the base being electroplated with indium.

20. A hard disk drive comprising:
a base;
a cover coupled to the base to create an internal cavity; and
means for sealing the internal cavity using indium.
